(19) United States
(12) Patent Application Publication
(10) Pub. No.: US 2012/0239531 A1
(43) Pub. Date: Sep. 20, 2012

(54) FACILITATING E-COMMERCE PAYMENTS USING NON-ACCEPTED CUSTOMER PAYMENT METHODS

(75) Inventor: Daniel McCann, Regina (CA)

(73) Assignee: NETSECURE INNOVATIONS INC, Regina Saskatchewan, CA (CA)

(21) Appl. No.: 13/496,374

(22) PCT Filed: Sep. 15, 2010
(86) PCT No.: PCT/CA2010/001451

§ 371 Date: Jun. 1, 2012

(30) Foreign Application Priority Data
Sep. 15, 2009 (CA) 2678831

(51) Int. Cl. G06Q 20/12; G06Q 30/06

(52) U.S. Cl. 705/26.41

(57) ABSTRACT

A method of providing e-commerce payment functionality between a customer and a vendor wishing to provide or accept alternate methods of payment. The vendor website initiates a transaction payment request identifying the selected customer payment method, the transaction amount, and the desired vendor payment method to a payment facilitation bureau which processes payment for the transaction amount to the selected customer payment method and issues transaction payment credentials to the vendor in a transaction payment response. The vendor e-commerce platform can then process payment for the transaction to the selected vendor payment method using the issued payment credentials. Various vendor payment methods and customer selected payment methods could be used, and the method allows for the bridging of incompatible pairings of payment methods. Client and server level software for use in this payment method is also disclosed.

This invention is in the field of electronic commerce transaction processing, and more specifically provides a novel payment method by which vendors can accept payment for e-commerce transactions from customers who wish to pay using payment methods for which the vendor does not have processing infrastructure in place.

### BACKGROUND

One of the limitations experienced by companies wishing to accept or process e-commerce transaction payments is the limitation imposed by the specific transaction processing infrastructure available to that company or vendor. For example, most companies have in place registrations with one or more credit card companies with the necessary account codes etc. by which they can charge transactions to that particular companies credit card type in acceptance of payment from customers. Most vendors however do not have every type of credit card authorization a registration in place and on this basis they may be limited in terms of the types of credit cards they can accept. For example, a vendor may be registered to accept payments on Visa™ or MasterCard™ credit cards, but may find themselves from time to time with customers wishing to use an American Express™ credit card to pay for their products or services and if the vendor does not have the necessary registration in place with American Express to facilitate these payments it is not possible for them to receive payment in this way and they may lose a customer or a transaction.

Beyond the limitations imposed by the number of different credit card vendors that are available in the marketplace, some customers may actually also wish to pay using different methods of payment such as a debit card, bank account debit, gift card or the like. Different types of processing infrastructure are available and required to process each type of a transaction—for example if it was desired to be able to accept a debit card or some kind of a bank account transaction from customers, it may be necessary for a vendor to have a significant number of additional security and software components installed in their e-commerce environment to provide this capability. Beyond the added infrastructure and overhead associated with this approach for the vendor, customers may also be modestly concerned about security in a debit card transaction and providing the necessary particulars to execute such a transaction against their bank account. If it was again possible to provide a means of processing debit card, gift card or other types of payment methods to a vendor that had a basic credit card processing infrastructure available in their e-commerce environment this would be beneficial. Credit card or debit card transactions could be made more secure for the consumer if a method of payment could be developed which would either significantly enhance the security of the consumers information or restrict the information which would be transmitted to the vendor in such a way that the risk of interception or misappropriation of that information would be negated or minimized.

In most cases vendors already have the ability to process credit card transactions so it would be desirable to provide a cross-platform payment facilitation method which would not require significant additional infrastructure at the vendor site and would allow for a broadening of the types or methods of payment which could be accepted, which would operate using traditional credit card payment processing infrastructure so that additional or specific modifications were not required to be made at the vendor end, enhancing the likelihood of a broader rollout from the vendor community. Ideally in a case where the payment method operated completely within traditional credit card payment processing infrastructure or methods, it is contemplated that the provision of a payment facilitation method such as this could be actually entirely driven from the client end or the customer end such that it would simply operate within existing websites and within existing e-commerce transaction flows without the need for any customization whatsoever in the vendor environment.

### SUMMARY OF THE INVENTION

The object of the present invention is to provide a payment facilitation method for use in e-commerce transactions which would allow for a consumer to purchase goods or services using payment methods other than those accepted directly by the vendor, where the vendor e-commerce environment was already configured to accept one or more payment methods.

It is the further object of the present invention to provide a payment facilitation method for use in e-commerce transactions which would allow for the processing of payments for goods or services in a vendor e-commerce environment using a method of payment other than that for which the vendor's environment was directly configured, optimally without the need for any infrastructure changes in the vendor e-commerce environment.

A payment facilitation method which would multiply the number of payment methods which could be used by customers to purchase goods or services in e-commerce transactions would have specific utility in the promotion or use of debit cards or other payment methods by consumers and might also be desirably employed by vendors to broaden the rollout or market acceptance of their service offerings in e-commerce methods insofar as it would enhance the number of types of payment methods which were available for customers. The cross-platform payment method of the present invention also has security benefits insofar as the cross-platform nature of the method results in the anonymization of transaction payments from customers to vendors.

The method of the present invention, being a method of facilitating an ecommerce transaction payment between a customer and a vendor web site system having the necessary components to process transaction payments via at least one vendor-accepted payment method, comprises the following steps:
a. Generating and communicating to a payment facilitation bureau a transaction payment request containing at least the following:
   i. The transaction payment amount; and
   ii. Identification of the selected customer payment method; and
   iii. Identification of the selected vendor-accepted payment method;
wherein the payment facilitation bureau is capable of processing transaction payments to the selected customer payment method;
and wherein the payment facilitation bureau is capable of issuing payment credentials which can be used to provide a transaction payment using the selected vendor-accepted payment method;
b. Upon receipt of a transaction payment request by the payment facilitation bureau, generating a transaction payment response by:
   i. Obtaining from the customer the necessary customer payment credentials to permit the charging of a transaction payment to the selected customer payment method;
   ii. Processing payment for the transaction payment amount to the selected customer payment method using the acquired customer payment credentials by a connection to at least one payment processing gateway;
   iii. Upon confirmation of payment being obtained from the selected customer payment method, issuing vendor payment credentials usable by the vendor web site system to charge the transaction payment amount to the selected vendor-accepted payment method, by a connection to at least one payment issuing gateway; and
   iv. Transmitting the transaction payment response to the vendor web site system identifying the issued vendor payment credentials;

Upon receipt of a completed transaction payment response, which would contain valid vendor payment credentials which could be used by the vendor website system to process payment for the transaction in question to the selected vendor payment method, the vendor website system could use those vendor payment credentials to finalize payment for the transaction and the interaction with the customer.

The method of the present invention would also possibly comprise the step of acquiring the details of the customer selected payment method from the customer during the e-commerce transaction either via the vendor website system interaction with the customer, or via the interaction of the customer directly with a website system of the payment facilitation bureau. If the method were practiced whereby the customer payment method details were acquired directly by the payment facilitation bureau rather than being provided by the customer to the vendor, an additional layer of security or anonymization is also provided by practicing the method of the present invention. Either method of interaction with the customer to provide the customer payment method details, either directly to the vendor website system or through a website system or related software directly from the customer to the payment facilitation bureau, are contemplated within the scope of the present invention. Another additional step in the method of the present invention might also comprise the actual completion of the transaction payment by the vendor website system upon receipt of a transaction payment response by same.

In addition to the basic method of the present invention, the client software which is used at the client computer of a customer to interface with the payment facilitation bureau outlined herein and which is capable of formulating and transmitting payment requests to a payment facilitation bureau server for handling in accordance with the method of the present invention is disclosed. The client software could in many embodiments actually capture the customer payment credentials in respect of the selected customer payment method and incorporate those into the generation of the transaction payment request which could be transmitted directly from the client computer to the payment facilitation bureau, such that the customers payment credentials were never communicated or transmitted directly to the vendor website system. The transaction payment response could then be transmitted directly back to the client software on the customer computer, or could be transmitted directly to the vendor website system.

Communications between the vendor website system and the payment facilitation bureau, as well as between the customer and the payment facilitation bureau, could be conducted using a secure communication protocol or various types of encryption, to ensure the security of the payment details and information contained within the various communications in the practice of the method.

Various types of vendor accepted payment methods are contemplated. It may also be the case that a vendor website system was capable of accepting payments by more than one vendor accepted payment method and the transaction payment request transmitted to the payment facilitation bureau would need to identify the desired vendor accepted payment method so that the proper payment credentials could be generated and issued by the payment facilitation bureau to facilitate the e-commerce transaction payment question. It is specifically contemplated that the primary type of vendor accepted payment methods would be pre-existing credit card payment types, bank cards, debit cards, gift cards, a customer loyalty program redemptions or direct bank account debits, since the method of the present invention could be used to broaden the types of payments which could be accepted by vendors who already had the necessary infrastructure in their e-commerce environments to accept credit card payments of certain types without requiring them to broaden their own infrastructure or systems. It will however be understood that any type of a payment method which can be facilitated in an e-commerce environment could be used as an accepted vendor payment method so long as the payment facilitation bureau could be properly equipped to issue payment credentials for such payment method and communicate same within a transaction payment response as otherwise outlined herein.

The types of customer desired payment methods which could be used in accordance with the method of the present invention are also myriad. Customer desired payment methods might include credit card types which were not accepted by the vendor website system, through to debit cards or bank transactions, or even customer loyalty rewards or points programs at an extreme opposite end of the spectrum. Again, any type of a customer desired payment method could be used so long as that customer desired payment method could be identified within a transaction payment request in accordance with the present invention and credentials could be captured or acquired by the payment facilitation bureau to process payment for the e-commerce transaction in question to the desired customer payment method against which a corresponding set of vendor payment credentials could be issued. All types of customer desired payment methods as well as vendor accepted payment methods will be understood and contemplated to be within the scope hereof.

The payment facilitation bureau would comprise one or more servers operatively connected to one or more payment processing gateways by which the payment facilitation bureau could process payments of various types to the different customer payment methods outlined by customers in their payment requests, and it would then also be operatively connected or capable of facilitating the real-time issuance of payment credentials in respect of the acceptable vendor payment methods such that upon confirmation of processing of the payment to the customers selected payment method in respect of a particular transaction and transaction payment request, the payment facilitation bureau could issue payment credentials in respect of the selected vendor accepted payment method for that transaction and transmit those back to the vendor website system for use by the vendor website system and processing payment for the transaction in question. As outlined elsewhere herein it is specifically contemplated that the primary type of vendor accepted payment method which would be accommodated using the service bureau and method of the present invention would be to permit vendors to accept acceptable credit card payments in the place of unaccepted credit cards or other payment methods for e-commerce transactions. Without limiting the generality of the foregoing it is specifically contemplated that one time disposable credit card numbers and related payment credentials could be issued in the transaction payment response such that the vendor who had pre-existing credit card processing infrastructure in place could obtain payment for the transaction in question using the one-time disposable credit card number and related security information which would be provided as the vendor payment credentials.

There is also disclosed a data processing system for facilitating an ecommerce transaction between a customer and a vendor website system having the necessary components to process transaction payments by at least one vendor accepted payment method, the data processing system comprising at least one processing unit; at least one memory storage device operatively coupled to the at least one processing unit; and a program module stored in the at least one memory storage device operative for providing instructions to the at least one processing unit, the at least one processing unit responsive to the instructions of the program module, the program module operative for:
1. receiving a transaction payment request in respect of an e-commerce transaction payment between a customer and a vendor website system 44, said transaction payment request identifying the transaction payment amount, the selected customer payment method, and the selected vendor accepted payment method;
2. obtaining customer payment method credentials by which the transaction amount can be charged to the selected customer payment method;
3. processing the transaction payment amount to the selected customer payment method using the obtained customer payment method credentials, via connection of the data processing system to at least one payment processing gateway;
4. upon confirmation of the acceptance of the request for payment of the transaction payment amount from the at least one payment processing gateway, effecting the issuance of vendor payment credentials usable by the vendor website system to charge the transaction payment amount to the selected vendor accepted payment method, via connection of the data processing system to at least one payment issuance gateway;
5. assembling a transaction payment response in respect of the transaction payment request identifying the issued vendor payment credentials; and
6. transmitting the transaction payment response such that the issued vendor payment credentials can be used by the vendor website system to process payment in respect of the e-commerce transaction in question to the selected vendor accepted payment method.

This data processing system will be capable of effecting the method of the present invention including various embodiments outlined herein.

Finally the invention accomplishes its objectives comprising the client software program for use on the computer of a customer, in conjunction with the software and components of the payment facilitation bureau outlined herein, to accomplish the payment facilitation transaction handling outlined with or without the necessity to necessarily enter customer payment credentials through the vendor website system, thus providing enhanced security to the method.

### DESCRIPTION OF DRAWINGS

Preferred embodiments are provided in the accompanying detailed description which may be best understood in conjunction with the accompanying diagrams where like parts in each of the several diagrams are labeled with like numbers, and where:

FIG. 1 is a chart which shows the entities which are typically involved in the processing of a prior art credit card transaction payment in an e-commerce environment;

FIG. 2 is a business flow diagram demonstrating one embodiment of a prior art credit card transaction flow, against which the novelty of the present method and invention will be demonstrated;

FIG. 3 is a chart showing the entities which would be involved in one embodiment of the payment processing method which is the subject of the present invention;

FIG. 4 is a flow diagram demonstrating the basic steps of one embodiment of the e-commerce payment method of the present invention;

FIG. 5 is a system architecture diagram demonstrating one embodiment of the system of the present invention;

FIG. 6 is a flow diagram demonstrating one embodiment of the payment facilitation transaction of the present invention;

FIG. 7 is a diagram showing one basic embodiment of the data structure of a transaction payment request in accordance with the present invention;

FIG. 8 is a diagram showing an alternate embodiment of the data structure of a transaction payment request in accordance with the present invention;

FIG. 9 is a diagram showing one embodiment of the data structure of the transaction payment response in accordance with the present invention;

### DETAILED DESCRIPTION OF ILLUSTRATED EMBODIMENTS

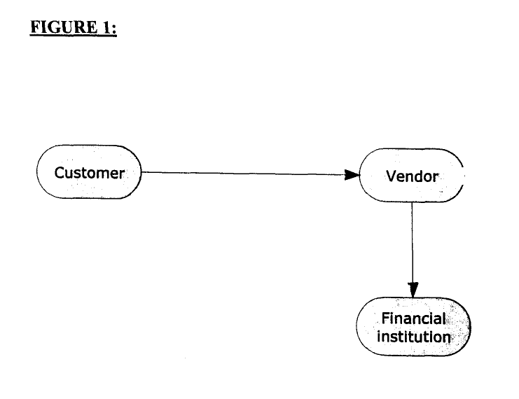

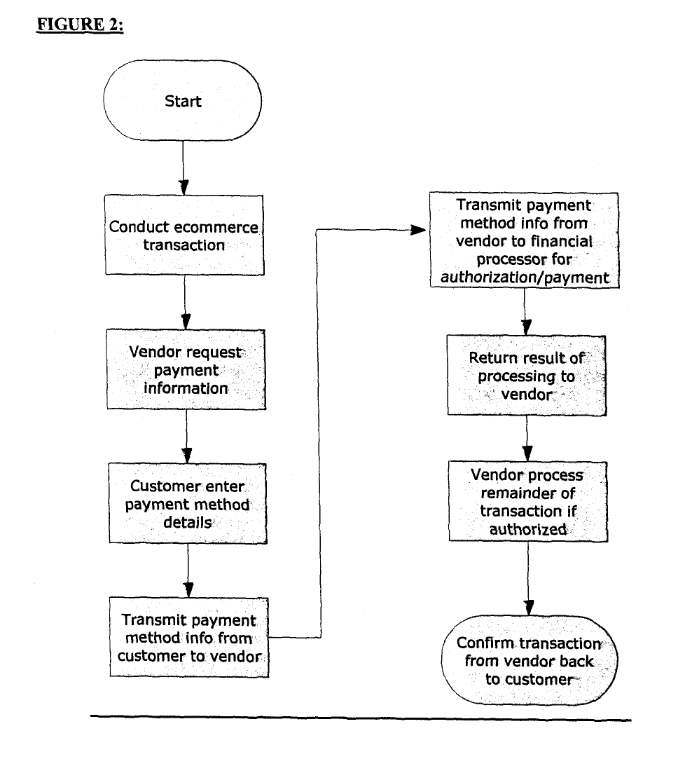

FIGS. 1 and 2 demonstrate the key elements of the data flow in a prior art e-commerce credit card transaction, which will be used for comparative purposes or to demonstrate the novelty of the system and method of the present invention. Referring first to FIG. 1 which simply demonstrates the entities who are typically involved in a e-commerce credit card transaction payment, there are shown the customer, the vendor and a credit card processing financial institution. In terms of the physical embodiment of the communication method between the customer and vendor, that is typically a client/server website system 44, with a server at the vendor and providing or serving information and content to the client browser or the client computer used by the customer.

The vendor website system 44 is typically in turn connected to one or more financial institution computer networks which allow the vendor website to submit credit card transactions or debit card transactions to the credit card processing financial institution network for authorization and payment. In operation of the vendor website system 44, one or more forms are served to the client browser of the customer into which the customer is required to enter their payment details such as credit card number and expiry date or their debit card number and any additional security codes or the like to allow for authorization of a transaction charge against that payment method. The vendor website would typically provide a layer of security to the customer by creation of a secure, between the customer's browser on the vendor website using the https protocol or the like, so that the customer could have some basic level of comfort with the security of the transmission of their information between themselves and the vendor's website the vendor website intern however then would transmit the customer's financial payment method information to at least one additional network connected computer system for payment authorization and processing—this would typically also take place securely but the customer may have some concern or apprehension about the overall security of the payment method insofar as it does require the provision of all of the necessary payment information to allow for the charging of a transaction amount against their debit card or credit card and the failure or weakness in the security of these communication channels could result in the open transmission of the customer's credit card or debit card payment information which could be misappropriated or otherwise compromised by a third party.

Referring to FIG. 2 there is shown for comparative purposes a basic prior art e-commerce transaction flow, which allows for the subsequent comparison or demonstration of the transformed payment method of the present invention. The first step which is shown in this Figure is the conduct of an e-commerce transaction of some kind between a customer and the vendor using an e-commerce website system 44. What is contemplated by this particular demonstrated transaction step would be for example the actual selection of products or services to a shopping cart, identification of a bill for payment etc. by the customer using a properly enabled website system 44 provided by the vendor.

Once the e-commerce transaction has been specified or initiated by the customer, the vendor would request payment information. This is the next step shown in this Figure. The requesting of payment information by the vendor would as outlined above typically be the provision of a form or other similar interface through which the customer could provide to the vendor their credit card or debit card payment details for payment for the transaction in question. For example, typically in a credit card transaction the vendor would provide a form that allow the customer to enter their credit card number, the expiry date or security codes from their credit card, and typically the credit card billing address as well, all of which information would then be retained and used by the vendor for the purpose of authorizing a transaction payment against that card. The entry of the customer payment information is shown as the next block in this diagram.

Once the customer entered their payment method details, related to their credit card, debit card or the like, in this prior art approach, a customer from their client computer would transmit to the vendor website that payment information. Transmission of the credit card or debit card payment information from the customer to the vendor, regardless of the security of the communications channel or, between the vendor website and the customers Web client computer is the first perceived security risk in this prior art method which is intended to alter with the present invention. In any event though the transmission of that payment method information from the customer through their web browser or client computer to the e-commerce website system 44 of the vendor would be the next step involved in the authorization of payment.

Upon receipt of the payment method information transmitted from the client computer to the vendor website system 44, the vendor website system 44 would in turn transmit that payment information upon its further assembly or processing to a financial institution for authorization or payment. For example where the customer is paying for their goods or services by credit card, the vendor upon receipt of the credit card details from the customer via the website system 44 would transmit those credit card details to one or more financial institutions in order to obtain an authorization and/or payment. Once an authorization or payment was confirmed by the credit card or other financial processing institution back to the vendor, the vendor would complete processing of the remainder of the transaction vis-á-vis the customer and confirm that back.

### Payment Facilitation Transaction:

At the heart of the method of the present invention is a new approach to the processing of e-commerce transaction payments which allows for the facilitation of payments between customers and vendors incorporating a step into the process whereby the actual payment method and credentials required for execution of same are interchanged during the course of finalizing the payment step of the e-commerce transaction. Effectively the transaction which is executed is a two-sided payment transaction, where an intermediate service bureau recovers payment for the transaction amount from the customer and their selected payment method, and then issues a set of payment credentials which can be used by the vendor to finalize payment for their transaction in accordance with accepted payment method for the vendor's website system 44.

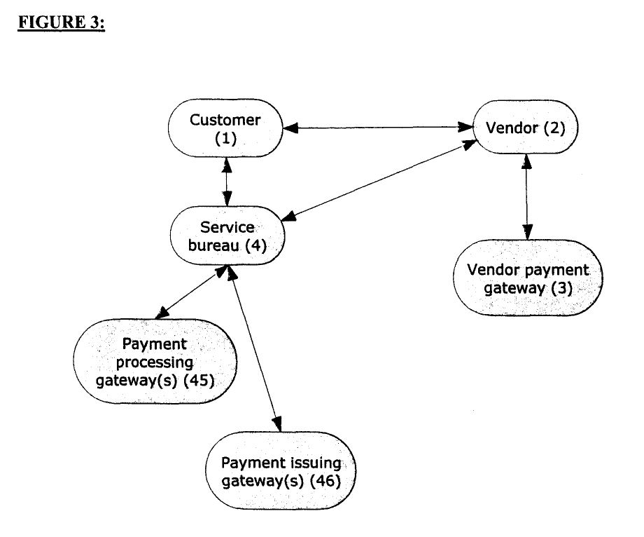

Referring first to FIG. 3, there shown the parties who are engaged in the practice of the method of the present invention. There is shown first of all a customer 1, who in the typical e-commerce context would be engaged in the conduct of an e-commerce transaction with a vendor website system 44. The vendor 2 is also shown. Again as is indicated it is typically conceived that the vendor 2 would operate and e-commerce capable website through which payments would be desired to be received either for the sale of products or services through the website or in some other debt or payment processing context. The vendor website system 44 47 will be shown in further detail in the following Figures.

As is shown in this Figure, vendor 2 through their website 47 is operatively connected to one or more payment processing gateways. These would typically get credit card processing institution or network 3. Basically the vendor website 47 needs to have some type of connection to a financial system which allows them to process payments for transactions. One of the key benefits of the transformed method of the present invention is that it allows for an added level of security as well as the implementation of electronic payments to vendors who have only conventional credit card or payment processing technology in place in their existing infrastructure, regardless of the additional requirements which might exist for the processing of transaction payments using alternate payment types including debit cards, customer loyalty cards or the like. One of the key aspects of the present invention making it novel and desirable over the current state-of-the-art is the fact that even for the processing of debit cards or other payment methods which might have slightly different requirements in terms of data capture or otherwise from conventional credit card processing, capturing the necessary payment information related to those payment methods is relegated to a payment facilitation bureau 4, rather than the vendor 2, which allows for the proliferation of the use of alternate payment methods including these types of debit cards or the like in e-commerce environments without any need for significant adjustment to the credit card or payment processing infrastructure which is already in place in the e-commerce environments of multiple vendors 2.

There is shown a payment facilitation bureau 4 which is at the heart of the present invention. The payment facilitation bureau 4, which might actually be a separate website system 44 operatively connected for communication with the browser or client of the customer 1, or might comprise local software installed on the customers computer, or some combination thereof, will accomplish or perform the key tasks of the method of the present invention through its own interface with at least one payment processing gateway and at least one payment issuing gateway.

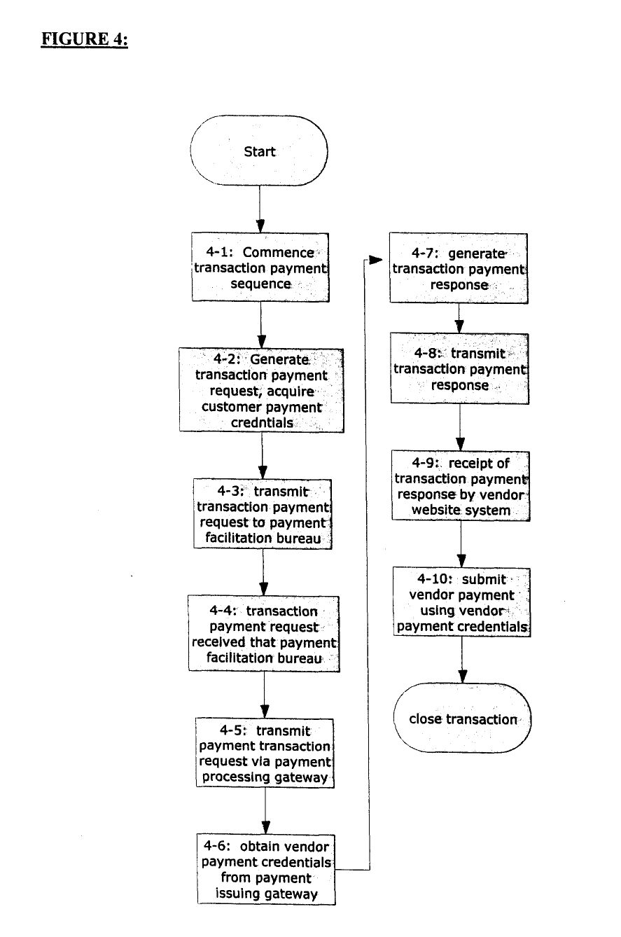

Referring to FIG. 4 there is shown a flow diagram of one embodiment of the general method of payment facilitation in an e-commerce environment in accordance with the present invention. The e-commerce environment which would be in place or would be used in the transaction between the customer 1 in the vendor 2 would be a website system 44, wherein the server of that website system 44 which was operated by or on behalf of the vendor 2 would serve various content eyebrows were client computer of the customer 1 including static or dynamic content which could be used in the conduct of an e-commerce transaction between the customer and the vendor. For example in the typical online shopping transaction the website would potentially serve content to the customer which would display products or services and/or allow for different interaction with the website resulting in the aggregation of purchase details for a particular purchase or payment processing transaction. The method of the present invention is contemplated to come into play when the customer 1 is ready to “checkout” from their transaction with the vendor website system 44 and process their payment. This is shown at step 4-1, being the initiation of a transaction payment sequence on the vendor website system 44. The transaction payment sequence is no particular technical definition beyond signifying the point in an e-commerce transaction or an interaction between the customer and vendor website system 44 where the vendor website system 44 would request payment method details from the customer to finalize the transaction in question.

The first step in the method of the present invention upon initiation of a transaction payment sequence is the generation of a transaction payment request 30, which is shown at 4-2. There two different approaches to the generation of the transaction payment request 30 which are specifically contemplated—the first of these is that the transaction payment request 30 would be entirely generated by the vendor website system 44 itself and transmitted to the payment facilitation bureau 4 by the vendor website system 44. The second embodiment which is likely more secure from the customer's perspective contemplates interaction between the browser or client computer of the customer 1 and the vendor website system 44 in the creation of the transaction payment request 30 for communication to the payment facilitation bureau 4. In either case the transaction payment request 30 which indicates the details of the transaction with the vendor website system 44 which it is desired to initiate a payment for by the customer is created containing identifying information for the transaction, information identifying the desired method of payment for the customer, payment credentials for the selected customer payment method, and indication of the selected or desired acceptable payment method for the vendor. The contents and structure of the transaction payment request 30 are outlined in further detail below.

In the circumstance that the customer payment credentials are going to be entered directly by the customer via their own computer or browser directly to the website system 44 of the payment facilitation bureau 4 rather than through the website system 44 of the vendor, the software of the present method of operating in conjunction with the website system 44 of the vendor in the browser or client of the customer would present a screen or interface through which the customer 1 could enter their customer payment credentials for use in the further processing or completion of the transaction. Either on automatic basis, where the software of the present invention installed on the client computer use by the customer 1 could detect the presentation of a payment input screen, or where the software of the present invention allow the user or customer 1 to manually initiate its use by some user interaction such as clicking a button or menu item in their browser, the customer would enter for acquisition by the payment facilitation bureau 4 their customer payment credentials which would be the necessary information to be used by the payment facilitation bureau 4 in conjunction with its connection to at least one payment processing gateway 45 to effect a payment transaction against the selected customer payment method in favor of the payment facilitation bureau 4.

As is outlined in further detail elsewhere herein, it is specifically contemplated that the selected customer payment method may be a payment method which is or is not accepted by the vendor on the vendor website system 44. If the customer wishes to pay using a payment method which is accepted by the vendor but they wish to use the system and process of the present invention to provide additional security in their handling of transactions they may do this, or the system and method of the present invention can also be used to effectively bridge incompatible payment systems, whereby a customer wishing to pay using a payment method not accepted by a particular vendor could pay in that fashion and have the vendor receive their payment by an accepted payment method.

The transaction payment request 30 is transmitted to the payment facilitation bureau 4, shown at 4-3. This Figure shows the creation of the generation of the transaction payment request along with the transmission and receipt thereof by the payment facilitation bureau. In its broadest sense, method of the present invention covers simply the receipt of the prepared transaction payment request by a payment facilitation bureau in accordance with the present invention and all such modifications are gained contemplated within the scope of the present invention.

Upon reception of the transaction payment request 30 by the payment facilitation bureau 4, shown at 4-4, the system of the payment facilitation bureau 4 would effectively execute two financial transactions to facilitate the handling of payment between the customer and vendor. The payment facilitation bureau 4 is operatively connected to at least one payment processing gateway corresponding to different types of customer payment methods which might be desired to be used by customers to pay for transactions. Based upon the selected customer payment method identified in the transaction payment request 30 and the customer payment credentials which are acquired from the customer permitting the processing of a payment request against their selected payment method, along with the remainder of the transaction identifying information such as the amount of the transaction etc., the payment facilitation bureau 4 would submit a transaction for payment through the at least one payment processing gateway in the amount of the transaction [or in the amount of transaction plus some handling fee etc.]. Submission of a payment transaction request on behalf of the payment facilitation bureau 4 via the at least one payment processing gateway 45 operatively connected thereto is shown at step 4-5.

Upon receipt of confirmation by the at least one payment processing gateway that the payment has been processed in their favor, the payment facilitation bureau 4 would then via connection to at least one payment issuing gateway effect the acquisition or issuance of vendor payment credentials i.e. a credit card number or other related security information, in respect of which a transaction in favor of the vendor website system 44 in the amount of the transaction could be authorized. 4-6.

Shown next at 4-7 is the generation of a transaction payment response. The transaction payment response 35 as outlined elsewhere herein is the data transmission which includes the vendor payment credentials required for the vendor to process payment on the e-commerce transaction, and this packet or response would either be transmitted directly to the vendor website system 44 or in certain embodiments would be transmitted back to the client computer of the customer which would in turn forward same to the vendor website system 44. Either approach is contemplated herein, and is shown at 4-8. These vendor payment credentials would then be communicated back to the vendor website system 44 either directly or by way of the computer or browser of the customer, and the vendor website system 44 would upon receipt or parsing of the transaction payment response effect the submission of a payment request via its own payment processing gateway connection or pre-existing infrastructure in accordance with the selected or desired accepted vendor payment method.

Shown at 4-9 is the receipt of the transaction payment response by the vendor website system 44. At this step in the process, the transaction payment response would be parsed are interpreted by the software components of the present invention on the vendor website system 44 and the vendor website system 44 would obtain from the transaction payment response the necessary vendor payment credentials to allow it to submit a transaction via its pre-existing processing gateway and predetermined or preselected accepted vendor payment method, to obtain payment for the transaction in question. Following submission of the vendor payment using these credentials, 4-10, the transaction could be closed.

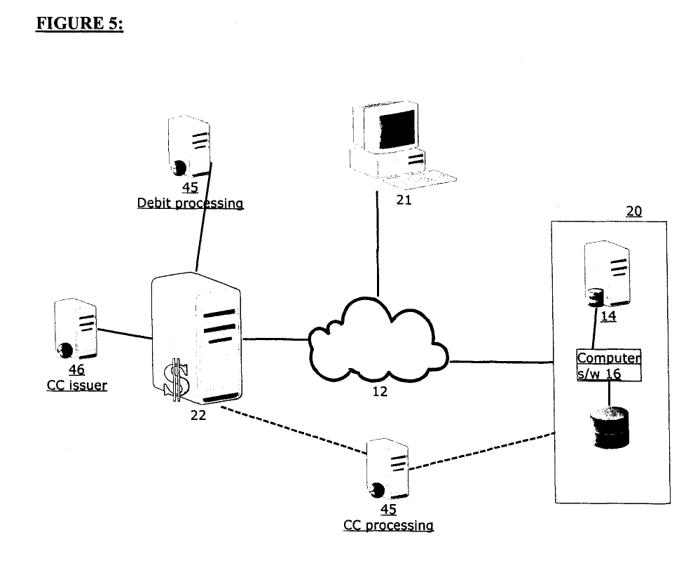

Referring to FIG. 5, there is shown one embodiment of the system architecture of the present invention which is intended to not only demonstrate a typical vendor website system 44 but also to showing general view the remaining anticipated system components of the present invention.

As outlined elsewhere herein, overall it is anticipated that the general nature of the system and method of communication between the customer 1 and the vendor 2 will be by way of a vendor website system 44 20 in communication with one or more clients or browsers each used by customer 1. The client or browser computer is demonstrated at 21. The payment facilitation bureau 4 would actually comprise another Web server 22 or a networked server in any event, capable of communicating with the client computers 21. The network cloud 12 is shown, signifying the network connectivity of the vendor website system 44 20, the client computers 21 and the payment facilitation bureau server 22.

Also shown connected to the payment facilitation bureau server 22 is another server 23 which is intended to demonstrate the connectivity of the payment facilitation bureau server 22 with a credit card issuer such that the credit card issuer could facilitate the issuance of one-time credit card numbers for use in Association with the remainder of the method of the present invention. For demonstrative purposes in this Figure, it is intended that the server 23 demonstrates the credit card issuer.

Within the vendor Web site system 20, there is shown a server 14 as well as a database of content and related software 16 which allows for the general conduct of interaction with customers as well as the creation or conduct of e-commerce transactions for which payments are required, and in respect of which the transformed payment method of the present invention would be used. The different components of websites are well known to those skilled in the art of their design and implementation and it is not felt that the specifics of a particular website architecture will affect in any event the operability of the method or the remainder of the system of the present invention.

The client computer 21 would likely contain an Internet browser program or the like capable of interacting with the website 20. The client computer 21 would also include client software or instructions, either freestanding, plug-in, applet or otherwise, which would allow for communication between the client computer 21 and the server 22 of the payment facilitation bureau 4.

The key to the website 20 is that in turn is connected by way of software or hardware components to a credit card processing network, whereby the server 14 can serve to a user at their user computer 21 the necessary forms or content to secure from that user at their computer 21 credit card details for the processing of a credit card payment incompletion of an e-commerce transaction. Any website 20 which has the necessary components to process credit card transaction payments either internally or by connection to an external third-party credit card processing system will be capable of functioning in accordance with the remainder of the present invention. For the sake of demonstration, there is shown a credit card processing gateway 24 which would be in communication with the website 20. In this particular case the credit card processing gateway 24 would also be in connection with the payment facilitation bureau server 22 although additional gateways or separate gateways 24 might be used in certain embodiments of the system as well. For demonstration purposes the mutual conductivity or shared conductivity of the website 20 and its associated server 14, and the payment facilitation bureau server 22, to the same credit card processing server 24 whether that be by the Internet or some other communication protocol is demonstrated with the dotted lines shown in this figure.

The number of different types of network infrastructures or designs within which the method of the present invention could be implemented or practiced is virtually limitless and different types of infrastructure designs within which the method of transformed payment handling of the present invention could or was practiced are all contemplated within the scope of the present invention.

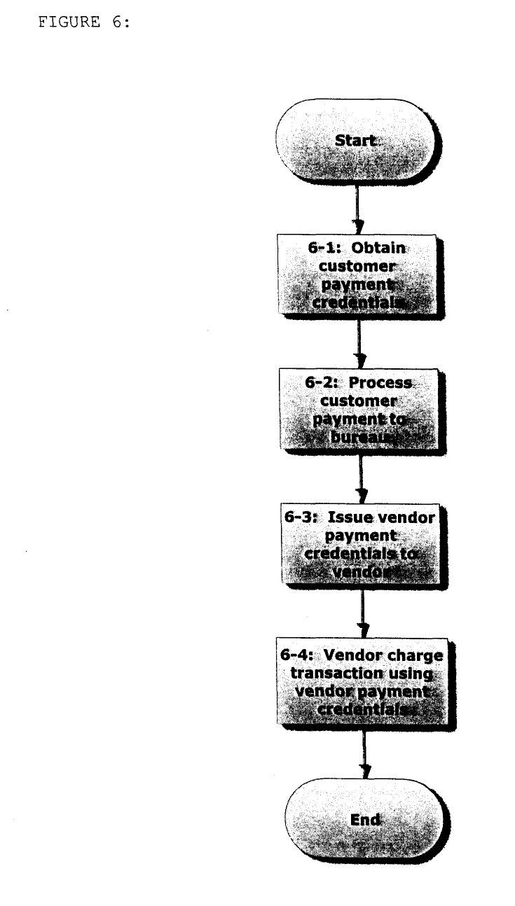

FIG. 6 is a flow diagram which demonstrates the basic steps involved in a payment facilitation transaction in accordance with the present invention. As is outlined herein, the general nature of the method of the present invention is that upon initiation of a payment for an e-commerce transaction with the vendor website system 44 by a customer, a transaction payment request identifying the transaction, the customers desired payment method and the accepted payment method of the vendor is created and transmitted to a payment facilitation bureau 4. The transaction payment request can be transmitted to the payment facilitation bureau numeral for either from the client computer of the customer 1, or in other embodiments from the vendor website system 44. Upon receipt of the transaction payment request, the payment facilitation bureau 4 would acquire the necessary credentials from the customer to process the payment in the amount of the transaction against their desired customer payment method [for example they would obtain the customer's credentials to initiate a debit card transaction, a credit card transaction to their credit card of choice etc.]. Transmission of the transaction and customer payment method credentials and details to the payment facilitation bureau 4 is shown at step 6-1.

With the customer payment credentials in hand, the payment facilitation bureau 4 would submit them via the connection to the at least one payment processing gateway 45 a payment request against the payment method selected by the customer and communicated in the transaction payment request. This is shown at step 6-2.

Upon receipt of confirmation of the availability or completion of that payment from the customer effectively to the payment facilitation bureau, the payment facilitation bureau would then via its connection to at least one payment issuing gateway issue payment credentials for communication to the vendor website system 44 (step 6-3) which would allow the vendor website system 44 to charge the amount of the e-commerce transaction in question to accepted payment method for that website (step 6-4). For example, if the vendor website accepts only one type of a credit card, the payment facilitation bureau 4 would issue the necessary credentials by way of a transaction payment response which when passed through the vendor website system 44 could be handled by the software components in the vendor website system 44 in the same way as it would handle a regular credit card payment and could submit from the vendor a transaction for approval to the credit card company in question—the vendor would receive their payment and the customer would receive completion of their transaction.

There will be many obvious variations or refinements and enhancements to the general method of the present invention that do not depart from the obvious scope thereof, which is to generally speaking provide an e-commerce payment method whereby a third-party payment facilitation bureau is deployed to issue one time or disposable credit card numbers or other vendor payment credentials for use in e-commerce transactions, wherein the original customer payment method details are never disclosed to the vendor and the vendor can process the transaction using traditional and pre-existing credit card payment processing infrastructure regardless of the specific type of customer payment method which is used by the customer. Further enhancements or refinements that do not depart from the general scope of this method as outlined are all contemplated within the scope of the present invention.

### Customer Payment Methods:

The general concept of the present invention is to provide a method by which either for the purposes of security of customer information or for the purposes of interchangeability of payment methods, payments for e-commerce transactions between customers and vendors can be facilitated in circumstances where the customer is selected payment method is not a payment method acceptable to the vendor.

Beyond circumstances in which it is wished to provide the interchangeability of accepted and unaccepted customer versus vendor payment methods, it may also be the case that the system and method of the present invention would be practiced by a customer or in a circumstance where it was desired to effectively a non-demise or provide masking or security of the customers payment credentials or even their selection of specific payment method type vis-á-vis the vendor. For example, the method of the present invention could be used to facilitate a payment transaction where the payment transaction was being provided, in one example, by a Visa credit card by the customer, and the vendor would process it as a Visa credit card transaction, but the payment facilitation bureau 4 of the present invention would issue a disposable Visa number and credentials to the vendor for execution of the transactions such that the customer's actual credit card information even though it is the same type of credit card, was masked from the vendor website system 44. It will be understood by those skilled in the art that both such approaches could be taken and that either payment facilitation transactions where the selected customer payment method was a selected vendor accepted payment method, or where the selected customer payment method was not accepted by the vendor through their existing e-commerce infrastructure, are contemplated within the scope of the present invention.

The method of the present invention would allow for the use of many different types of customer payment methods that are not presently accepted by individual vendors without the need for any backend infrastructure changes at the vendor level for the processing of transactions using those alternate payment methods. These might include debit cards, gift cards or gift certificates, or credit cards, or other various types of payment methods—any type of a payment method which it was possible for the payment facilitation bureau to properly format and process an authorization or a transaction with whatever necessary or attendance software modifications were necessary thereto are contemplated within the scope of the present invention. In its broadest sense and implementation of the payment facilitation bureau 4 and the method of the present invention would be optimized where a maximum number of customer payment methods were accommodated as well as a maximum number of accepted vendor payment methods, to allow for the broadest possible proliferation of payment methods amongst the broadest possible number of vendors. In this particular embodiment the service Bureau would be a third-party service provider to multiple vendors although the method of the present invention could also be practiced by an individual vendor operating their own individual payment facilitation bureau 4.

The method of the present invention could be used to facilitate the use of direct debit transactions or debit card transactions, as have become more popular in the consumer or retail banking system of the last number of years, in an electronic or online environment. Processing of debit card transactions, while very similar to a credit card processing environment, requires the vendor to have a different infrastructure in place. For the sake of minimizing the security risk associated with direct payment banking transactions in an online environment as well as to provide a means by which direct debit or similar transactions could be processed by vendors using conventional credit card processing technology which they already have in place, the method of the present invention will be beneficial.

It may even be the case that simply for the sake of enhanced security, a customer wanted to use the system or method of the present invention to anonymize credit card payments in online transactions. The client interface between the customer browser and the payment facilitation bureau could be adjusted to allow for the processing of credit card transactions or for the use of a credit card which could be conventionally processed as the customer payment method—even in a circumstance where the credit card payment method that the customer was using to pay for the transaction was an accepted vendor payment method with respect that particular vendor website system 44, use of the system of the present invention would result in added security since the customers actual payment information would be obscured from the vendor

### Vendor-Accepted Payment Methods:

As with customer selected payment methods, any number of different types of payment methods could be accepted by vendors using the system and method of the present invention. The payment facilitation bureau 4 would simply need to be able to access a credential issuing gateway from which payment credentials could be issued for provision to the vendor website system 44 in respect of a particular transaction, regardless of the specific type of a customer selected payment method which was selected by the customer. Vendor accepted payment methods which are specifically contemplated include credit card payments, debit card payments or bank account transactions and the like, but it will be understood that with procedural modifications to the system of the present invention or provision of access to one or more additional credential issuing gateways, the system and method of the present invention could be modified to accommodate virtually any type of a payment method on behalf the vendor and that all such modifications in alternate embodiments are contemplated within the scope hereof.

The primary specific circumstance in which is initially contemplated that the method of the present invention will be applicable is in the issuance of one time credit card credentials for the payment of e-commerce transactions by a customer to a vendor website system 44. It will however be understood that different types of vendor accepted payment methods could also be accommodated—for example if the vendors website system 44 only accepted bank account or debit card type payments and the customer wished to pay with a credit card, the payment facilitation transaction could comprise executing the customer side of the transaction against the customer's credit card and providing bank account credentials in the transaction payment response against which the vendor side of the transaction could be executed. In its broadest sense and implementation of the payment facilitation bureau 4 and the method of the present invention would be optimized where a maximum number of customer payment methods were accommodated as well as a maximum number of accepted vendor payment methods, to allow for the broadest possible proliferation of payment methods amongst the broadest possible number of vendors. In this particular embodiment the service Bureau would be a third-party service provider to multiple vendors although the method of the present invention could also be practiced by an individual vendor operating their own individual payment facilitation bureau 4.

### Transaction Payment Request:

The transaction payment request 30 itself would be a data communication received by the payment facilitation bureau or server of the present invention, the receipt of which triggers the execution of a payment facilitation transaction. The precise format of the transaction payment request as a data packet could vary dependent upon the specific communication protocol used for communication between the bureau, the vendor website system 44 in the customer as well as based upon the specific final rendering of the software of the present invention for use either at the client computer of the customer and/or the vendor website system 44. This will be understood to those skilled in the art and the precise nature of the transaction payment request as a formatted communication to be received by the payment facilitation bureau will all be contemplated and understood to be within the scope of the present invention.

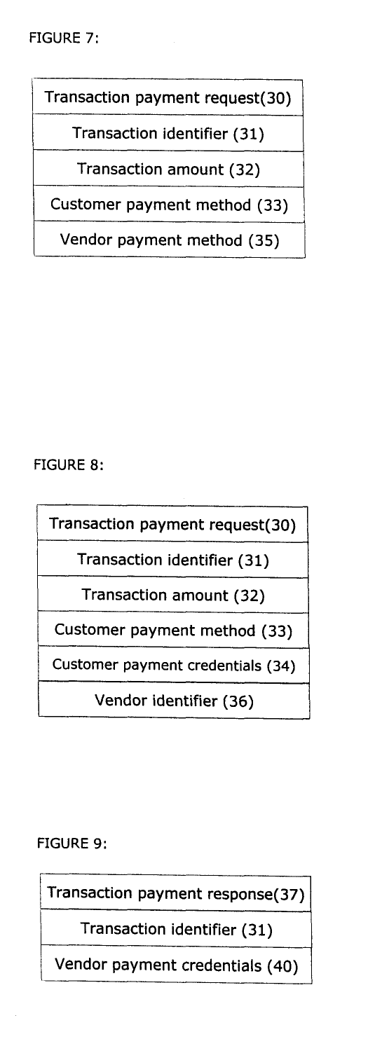

Referring to FIG. 7, there is shown one representative sample of a data structure which could comprise a transaction payment request for communication to the payment facilitation bureau of the present invention. The transaction payment request 30 would be a packet or data structure which could be transmitted to the payment facilitation bureau of the present invention to trigger a payment facilitation transaction as outlined above. Shown in the embodiment of the data structure of FIG. 7, there are three key data elements contained within that structure. The first item contained within that data structure is a transaction identifier 31 which could be a transaction tracking number or some other identification key or cookie which could be used by the vendor website system 44 to correlate a transaction payment response eventually received in respect of the transaction payment request 34 the final processing of the payment of the e-commerce transaction. The specific nature of the transaction identifier 31 could be dictated by the system in question but it will be understood to those skilled in the art that a serial key of some type such as this transaction identifier 31 would likely be used in respect of each transaction payment request 30 to identify the specific e-commerce transaction in respect of which the transaction payment request 30 was generated.

The next data token contained within that packet structure is the transaction amount 32. The amount of the payment sought in the transaction will be necessary for the payment facilitation bureau or hardware and software components to execute the facilitation transaction. The final necessary data field within this structure 30 as shown in this Figure is an indication of the selected customer payment method 33. It is necessary for the transaction payment request 32 to contain an identification of the payment method which the customer desires to use 33 to pay for the transaction, so that the payment facilitation transaction can be executed. For example, if the customer wishes to finalize their payment for the e-commerce transaction using a debit card payment or a particular type of credit card, that indication would comprise the selected customer payment method 33 within the transaction payment request 30.

This type of a transaction payment request format 30 could be used in an embodiment of the system of the present invention where there was only one vendor accepted payment method on the vendor website system 44 in question. If the vendor website system 44 was capable of accepting or processing payments via more than one payment method i.e. if the vendor website system 44 accepts credit card payments of more than one type etc., the transaction payment request 30 would likely also need to include some indication of the selected vendor accepted payment method 35 which it was desired to use in the payment facilitation transaction. The vendor accepted payment method 35 which was designated in this data structure 30 could be selected by the customer or could be dictated by the vendor website system 44. In other embodiments of the system and method of the present invention, it may also be the case that rather than a selected vendor accepted payment method 35 being contained within the transaction payment request 30 data structure there was an identification of the vendor themselves, and the vendor themselves had default stored within the system of the payment facilitation bureau of the present invention which could be accessed or correlated with the transaction payment request 30 when the vendor was identified in that data structure. Either such approach is contemplated within the scope of the present invention.

The data structure shown in FIG. 7 is most specifically contemplated for embodiments of the invention in which the customer payment method credentials 34 would be acquired from the customer at their client computer directly to the payment facilitation bureau 4, and the transaction payment request 30 shown in FIG. 7 would potentially be initiated or transmitted to the payment facilitation bureau 4 from the vendor website system 44. The following Figure demonstrates an alternate data structure in the circumstance where the transaction payment request 30 itself was initiated from the client computer of the customer and directly included the customer payment credentials 34.

Referring to FIG. 8 there is shown another sample of the data structure of a transaction payment request 30. This particular data structure again includes a transaction identifier 31, transaction amount 32 and a selected customer payment method 33. Additionally, there is shown customer payment method credentials 34. These would be the necessary credentials for the payment facilitation bureau 4 via the at least one payment gateway 45 to execute and obtain a payment in the amount of the transaction. If the selected customer payment method was a credit card of some type for example the customer payment credentials will include a credit card number and any other security information required to execute a transaction to charge against that card. Also shown is a vendor identifier 36. It is contemplated that the vendor identifier 36 is shown in this Figure, versus the selected vendor accepted payment method 35 shown in the embodiment of FIG. 7, demonstrate a circumstance where the vendor identifier 36 was provided to the payment facilitation bureau 4 and was correlated by the payment facilitation bureau 4 with vendor details including a default accepted vendor payment method in respect of that particular vendor and in respect of which vendor payment credentials 40 will be issued to back the customer payment method payment when received. Again the specific data structures of these transaction payment requests 30 will be understood to vary based upon many parameters and the programming of the overall system and method of the present invention will be understood that many approaches could be taken without departing from the intent and scope hereof.

### Vendor Web Site System:

There are very few specific requirements of vendor websites that would function in accordance or in conjunction with the remainder of the present invention. In fact one of the primary benefits of the method of the present invention is that the payment method outlined herein could be practiced in conjunction with any vendor website system 44 that included a conventional credit card processing mechanism. As will be understood by those skilled in the art, the real only requirement will be the basic ability for the vendor website system 44 to facilitate or accommodate a handoff back and forth in the payment process between the payment facilitation bureau 4 and its related components and the pre-existing payment processing infrastructure of the vendor website system 44 as the transaction payment request 30 is generated, and the details of the completed transaction payment response 37 or forwarded back to the vendor website system 44 for execution in the form of a payment to be processed against the selected vendor accepted payment method.

### Transaction Payment Response:

Referring next to FIG. 9 there is shown one example of a data structure of a transaction payment response 37 in accordance with the present invention. As with the transaction payment request 30 data structures demonstrated above, there are many possible specific implementations of the system and method of the present invention which would dictate to a large extent the specific formatting of the data packet or data structure which would make up the transaction payment response 37 which would be issued by the payment facilitation bureau 4. In the embodiment of FIG. 9, the data structure of the transaction payment response 37 in its most basic form includes a transaction identifier 38 which is a serial key related to the transaction at the vendor website system 44 and/or a serial number that in some way would correlate the transaction payment response 37 to the transaction payment request 30 which initiated same. In addition to the transaction identifier 38, the transaction payment response 37 shown in this Figure also indicates the vendor accepted payment method 39 and includes vendor payment credentials 40. The vendor accepted payment method 39 would be an optional field to contained within this data structure if the vendor had a default or single accepted payment method which was always used but if it was the case that more than one type of a payment method was accepted by the vendor website system 44, the transaction payment response 37 could indicate by a flag or field the type of vendor accepted payment method 39 in respect of which the payment facilitation transaction had been carried out. Finally, the embodiment of the transaction payment response 37 shown in this Figure includes vendor payment credentials 40 which would be the necessary credentials for the vendor website system 44 to execute payment of the e-commerce transaction in question against the designated vendor accepted payment method. For example if the vendor accepted payment method in respect of which payment would be received by the vendor was a particular credit card type, and the payment facilitation bureau 4 had issued a set of vendor payment credentials in respect of that particular credit card type, by passing the necessary payment credentials including security information back to the vendor website system 44 through the transaction payment response 37 the vendor website system 44 could then upon parsing the transaction payment response 37 received, either directly from the payment facilitation bureau 4 or from the client computer 44 of the customer, complete the e-commerce transaction payment which it was desired to facilitate using the method of the present invention.

As is outlined elsewhere herein, the transaction payment response 37 could be transmitted directly to the vendor website system 44 from the payment facilitation Bureau 4, or it could be transmitted upon receipt or creation thereof from the client computer 44 of the customer in respect of the transaction in embodiments of the method of the present invention where was desired to mask completely the customer payment credentials or customer selected payment method from the vendor. Either such approach is explicitly contemplated to be within the scope of the present invention.

Insofar as the remainder of the system and method of the present invention are specifically contemplated or intended for use in Internet e-commerce applications, it is anticipated that the payment facilitation bureau 4 would likely be operatively connected to the Internet and that the remainder of the communications with the payment facilitation bureau 4 would take place by way of a secure communications protocol over the Internet or a similar computer network [ie. HTTPS etc.]

### Payment Processing Gateway:

As is outlined elsewhere herein, the payment facilitation bureau 4 of the present invention, and the software method of the present invention, rely upon access of the system of the present invention to at least one payment processing gateway capable of processing customer payments. The payment processing gateway or gateways 45 would be the electronic systems through which the payment facilitation bureau 4 could forward for processing payments in respect of a particular payment transaction by a customer in accordance with the costumers selected payment method. For example, if it was desired to implement a payment facilitation bureau 4 in accordance with the present invention that was capable of handling customer payments via credit cards and debit cards, the payment processing gateway or gateways 45 to which the payment facilitation bureau 4 would be connected would need to either singly or in combination be capable of processing payments for transactions based on one or more customer payment methods using the customer payment credentials 34 which are acquired from the customer in the process of initiating the transaction payment request 30. The payment processing gateway 45 in respect of a credit card transaction for example the use of the customer payment credentials 34 in respect of a credit card customer payment method which would likely simply be a credit card number, and/or expiry or security information, to submit a transaction to the credit card company on behalf of the customer who have selected that is their payment method for a particular e-commerce transaction with a vendor website system 44, and could in turn also receive confirmation of the execution of the transaction.

The payment processing gateway or gateways 45 could be integral with the remainder of the payment facilitation bureau 4, or could be separate systems which were connected to the payment facilitation bureau 4 with the appropriate hardware and software components to allow for the secure exchange of payment method information etc. between them. Both such approaches are contemplated within the scope of the present invention. Any type of a payment processing gateway 45 which permitted the capture of confirmation of execution of a transaction payment from the customer effectively to the payment facilitation bureau 4 in respect of the e-commerce transaction in question are contemplated within the scope here of. The number or type of payment processing gateways 45 which could be used is limited only by the number of different types of desired customer payment methods 33 which was desired to support with the system and method of the present invention.

### Payment Issuing Gateway:

The second gateway or system tool to which the payment facilitation bureau 4 requires access to accomplish transactions in accordance with the present invention is at least one payment issuing gateway 46. A payment issuing gateway is a gateway or system connection by which the payment facilitation bureau 4 can obtain the issuance of the necessary payment credentials in respect of one or more vendor accepted payment methods such that vendor payment credentials could be issued by the payment facilitation bureau 4 in conjunction with the payment issuing gateway 46 and passed back directly or indirectly to the vendor website system 44 in or by way of the transaction payment response 37 to allow the vendor website system 44 to process a transaction by one of their accepted payment methods in accordance with the vendor payment credentials 40. For example, where the customer wish to make a debit card payment on thee website of a vendor who only accepted payment by credit card, the system of the present invention would by way of the payment processing gateway 45 described above execute the debit payment side of the transaction from the customer in favor of the payment facilitation bureau 4, and the payment facilitation bureau 4 would then turn to the payment issuing gateway 46 to issue a credit card number and the attached security credentials which would allow for the execution of the payment transaction by the vendor website system 44 in the amount of the transaction. It is specifically contemplated that in this type of a circumstance the payment issuing gateway 46 could be used to issue effectively one time use or disposable credit card numbers which were only authorized for the amount of the transaction 32 and the credit card number and related security information for those amounts would be passed back to the vendor website system 44 as the vendor payment credentials 40 in the transaction payment response 37.

As is the case with the payment processing gateway 45 it will also be understood that the payment issuing gateway or gateways 46 could be integral within the remainder of the payment facilitation bureau 4, or the payment issuing gateway or gateways 46 could also be external systems to the payment facilitation bureau 4 to which the appropriate system connections could simply be made to seek the issuance of vendor payment credentials in respect of a particular transaction. Either approach is explicitly contemplated within the scope hereof.

Also as is the case with the payment processing gateway or gateways 45, the payment issuing gateway or gateways 46 might comprise one or more than one in number, dependent upon the number of different types of vendor accepted payment methods 35 it was desired to accommodate in accordance with the payment facilitation method of the present invention. The key aspect of the payment issuing gateway 46 is simply that is capable of issuing the necessary credentials for passing to a vendor website system 44 via a transaction payment response such that the vendor website system 44 can then use those issued credentials to execute a payment transaction in accordance with the vendor accepted payment method and finalize and e-commerce transaction payment on behalf of the customer.

### Payment Facilitation Bureau Server Software:

The software which would be contained within the payment facilitation bureau server 22 would be a set of processor instructions capable of carrying out the method of the present invention, specifically capable of receiving a transaction payment request 30 by a network interface, and in response to the receipt of a transaction payment request 30 initiate in the execution of a payment facilitation transaction as outlined herein resulting in the transmission back to the vendor website system 44 of the vendor in question a set of vendor payment credentials in respect of accepted vendor payment method against which the amount of the e-commerce transaction in question could be rendered. Additional modifications or enhancements could be made to this basic payment facilitation bureau software approach but any type of a computer software which could be used on a server 22 or on more than one piece of computer hardware and connection which would accomplish the method of the present invention is contemplated within the scope hereof.

FIG. 5 also demonstrates the connection of two payment processing gateways 45 which would be capable of communication with the server 22. There is shown a credit card processing provider 24 as well as the debit card processing provider 25. In certain circumstances multiple types of payments to be processed using a similar payment processing interface are gateway could be accomplished using connection to a smaller number of payment processing gateway 45, but it is also contemplated that multiple types of payment processing gateways 45 might be required or desired for connection to the server 22 and that all such approaches are contemplated within the scope of the present invention.

### Customer Client Software:

It is contemplated that there would be a browser plug-in or other type of software operable on the user computer of the customer 1 which would allow the customer 1 to interact with the payment facilitation bureau 4 for the purpose of provision of their customer payment method details. Two specific types of software can be immediately considered or identified which would allow for the practice of the present invention in conjunction with various vendor website system 44s. The present invention could be practiced or facilitated either by use of a freestanding software program installed by the customer 1 on their desktop computer or client computer, or could also be a browser plug-in which was installed in the Internet browser of the customer 1 such that it could appropriately interact with the vendor website and at the appropriate time receive and transmit information between the customer and the payment facilitation bureau and the customer and the vendor. Both a freestanding software program as well as a browser plug-in, and any other type of an applet or implementation of a computer software which accomplish the same objective of providing the necessary processor instructions to the customer's computer and facilitated the remainder of the method of the present invention are contemplated within the scope hereof.

Varying degrees of automation or human interaction could be accomplished with the client software of the present invention. In a basic embodiment, the client software of the present invention might have a button or some other type of user interface within the browser of the customer 1 such that if they wish to invoke the payment system of the present invention they could do so by manually initiating its engagement with the preparation of a transaction payment request to the payment facilitation Bureau 4. Once the browser of the client was manually triggered in this type of approach, browser of the customer 1 could be redirected to a website operated by the payment facilitation bureau 4 for the handling of the creation of the transaction payment request—it will be obvious to one skilled in the art of website programming to provide for the redirection of the browser of the customer 1 to the payment facilitation bureau for the appropriate time and following the creation of the transaction payment request passed that information back either via the client browser of the customer 1 to the vendor website system 44 or directly to the vendor website system 44, and all such approaches the necessary modifications to the client software of the website content of the parties in question are contemplated within the scope of the present invention.

In a more automated format, even if the customer 1 manually initiated the payment of the e-commerce transaction by selecting a menu option or the like, the client software of the present invention either upon its local operation or by redirection to a website operated by the payment facilitation bureau 4 could be configured to automatically gather the necessary additional information for creation of the transaction payment request for submission to the payment facilitation bureau 4, or could also the very least upon invocation present a local software formerly type of data entry interface whereby the necessary customer payment credentials etc. could be entered.

The operation of the client in association with the payment facilitation bureau could be automated in some way so that the software of the present invention resident upon the client computer of the customer 1 would automatically recognize the presentation of a payment input form or payment request interface from the vendor website and automatically initiate communication with the payment facilitation bureau to facilitate the payment of the payment method of the customer, or alternatively there could be a interface or button or the like within the client browser of the customer 1 which could be used to manually trigger the interaction with the payment facilitation bureau.

For example if the customer was using the system and method of the present invention to enable a debit card payment to the vendor 2, the payment facilitation bureau 4 upon initiation of the payment request may serve to the browser of the customer 1 a form into which the necessary information could be gathered to process a debit card payment, and the payment facilitation bureau 4 then may contain the necessary additional software or hardware components to in turn process or authorize that debit card transaction or payment. The payment facilitation bureau 4 would contain all of the necessary components to complete the authorization or charging of a transaction payment to each allowable customer payment method which the system allowed the customer to use. For example the payment facilitation bureau 4 in a certain embodiment may allow for credit card and debit card transactions only where in some other embodiments there may be additional types of payment methods such as gift certificates, gift cards etc. which were also allowable for use, and to the extent that there needed to be modifications or additions made to the infrastructure of the payment facilitation bureau 4 to accommodate the processing of transaction payments to each such payment method, those changes are also contemplated within the scope of the present invention.

It is conceivable that the client software of the present invention, and the payment facilitation bureau 4 of the present invention, could work in conjunction with a pre-existing centrally hosted database of vendor form schema which would allow for the automated harvest of nearly all of the necessary information from a vendor website at such point in time as a payment was initiated, to fully or nearly fully automate the transmission of that particular information to the payment facilitation bureau 4 for the use in the processing of a payment request. Basically if the system recognized the specific payment form which is being presented by the vendor website, not only would that enable potentially the client software and the remainder of the system of the present invention to automatically identify and capture the amount of the transaction payment which was required, it could also facilitate the passing back of the transformed payment details once issued by the payment facilitation bureau [for example, if a recognizable form was presented to the user, the applet or other client software which is used for the practice of the method of the present invention could know where in the form to look to identify the amount of the transaction to communicate that, and could also identify the fields into which the transformed payment details i.e. the one-time credit card number, expiry date etc. which might be required for the charging or completion of the transaction to that one-time credit card number should be placed, and could then place the information into those fields and automatically submit the form]. Building this type of a database of form schema and deploying it along with the remainder of the payment facilitation bureau approach of the present invention would enhance the functionality and the seamless user experience which could be associated with the method of the present invention. Use of this type of approach is contemplated within the scope hereof.

Client software used at the client computer of the customer 1 to participate in the practice of the method of the present invention, either where the customer payment credentials are entered through a browser via the vendor payment website system 44 or by redirection or software operation locally on the computer of the customer 1 whereby they are communicated directly to the payment facilitation bureau 4 rather than being transmitted via the vendor website system 44 are all contemplated within the scope of the present invention.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method of facilitating an ecommerce transaction payment between a customer and a vendor web site system having the necessary components to process transaction payments via at least one vendor-accepted payment method, said method comprising:
a. Transmitting a transaction payment request to a payment facilitation bureau in respect of the e-commerce transaction, said request containing at least the following:
v. The transaction payment amount; and
vi. Identification of a selected customer payment method; and
vii. Identification of the selected vendor-accepted payment method;
wherein the payment facilitation bureau is capable of processing transaction payments to the selected customer payment method via a connection to at least one payment processing gateway; and
wherein the payment facilitation bureau is capable of issuing payment credentials which can be used to provide a transaction payment using the selected vendor-accepted payment method, via a connection to at least one payment issuing gateway;
b. Upon receipt of a transaction payment request by the payment facilitation bureau, generating a transaction payment response by:
viii. Acquiring from the customer the necessary customer payment credentials to permit the charging of the transaction payment to the selected customer payment method;
ix. Processing payment for the transaction payment amount to the selected customer payment method using the acquired customer payment credentials, via the at least one payment processing gateway;
x. Upon confirmation of payment being obtained from the selected customer payment method, issuing vendor payment credentials usable to charge the transaction payment amount to the selected vendor-accepted payment method, via the at least one payment issuing gateway; and
xi. Transmitting a transaction payment response from the payment facilitation bureau for use by the vendor website system, said response identifying the issued vendor payment credentials in respect of the transaction;
Whereby the vendor web site system can complete acceptance of payment for the ecommerce transaction from the customer using the issued vendor payment credentials.

2. The method of claim 1 wherein the selected customer payment method is a vendor-accepted payment method.

3. The method of claim 1 wherein the selected customer payment method is not a vendor-accepted payment method.

4. The method of claim 1 wherein the transmission of the transaction payment request to the payment facilitation bureau is initiated by the client computer of the customer.

5. The method of claim 1 wherein the transmission of the transaction payment request to the payment facilitation bureau is initiated by the vendor website system.

6. The method of claim 1 wherein the transaction payment response is transmitted directly to the vendor website system

7. The method of claim 1 wherein the transaction payment response is transmitted to the client computer of the customer, where it can be parsed or retransmitted to the vendor website system.

8. The method of claim 1 further comprising the step of acquiring the customer payment credentials from the customer during the ecommerce transaction via the vendor web site system in advance of the generation of the transaction payment request, and including those credentials in the generation of the transaction payment request.

9. The method of claim 1 further comprising the step of processing the transaction payment to the selected vendor-accepted payment method using the issued vendor payment credentials upon receipt of the transaction payment response by the vendor web site system.

10. The method of claim 1 wherein the customer payment credentials are acquired from the customer by the payment facilitation bureau, whereby the customer payment credentials are not provided to the vendor website system.

11. The method of claim 1 wherein the necessary customer payment credentials are acquired from the customer by interaction with the payment facilitation bureau upon receipt of the transaction payment request.

12. The method of claim 1 wherein communications between the vendor web site system and the payment facilitation bureau are conducted securely.

13. The method of claim 1 wherein communications between the customer and the payment facilitation bureau are conducted securely.

14. The method of claim 1 wherein the number of vendor-accepted payment methods is one.

15. The method of claim 1 wherein the number of vendor-accepted payment methods is more than one.

16. The method of claim 1 wherein the vendor-accepted payment methods are selected from the group of:
a. credit card payments;
b. debit card payments;
c. gift card payments; or
d. bank account direct transactions.

17. The method of claim 1 wherein the customer payment method is selected from the group of:
a. credit card payments;
b. debit card payments;
c. gift card payments;
d. customer loyalty program redemptions; or
e. bank account direct transactions.

18. A payment facilitation bureau capable of facilitating an ecommerce transaction payment between a customer and a vendor web site system having the necessary components to process transaction payments via at least one vendor-accepted payment method, said payment facilitation bureau comprising:
f. A payment facilitation server operatively connected to communicate with at least one vendor website system via a computer network, and capable of issuing vendor payment credentials which can be used to process a transaction payment using the at least one vendor accepted payment method and infrastructure of the vendor website system;
g. At least one payment processing gateway connected to the payment facilitation server and comprising the necessary hardware or software components to process transaction payments to at least one selected customer payment method;
h. At least one payment issuance gateway corresponding to the at least one vendor accepted payment method, connected to the payment facilitation server and comprising the necessary hardware or software components to allow for the issuance of payment credentials which can be used to process transaction payments in accordance with the vendor accepted payment method;
Wherein the payment facilitation server can receive a transaction payment request in respect of an e-commerce transaction identifying the transaction payment amount, the selected customer payment method and the selected vendor accepted payment method;
And wherein upon receipt of a transaction payment request, the payment facilitation server generates a transaction payment response by:
a. Obtaining from the customer the necessary customer payment credentials to permit the charging of a transaction payment to the selected customer payment method;
b. Processing payment for the transaction payment amount to the selected customer payment method using the acquired customer payment credentials via the at least one payment processing gateway;
c. Upon confirmation of payment being obtained from the selected customer payment method issuing vendor payment credentials using the at least one payment issuance gateway, usable by the vendor web site system to charge the transaction payment amount to the selected vendor-accepted payment method; and
d. Transmitting a transaction payment response identifying the issued vendor payment credentials in conjunction with the transaction, whereby upon receipt of said transaction payment response the vendor web site system can complete processing of payment for the ecommerce transaction from the customer using the issued vendor payment credentials via the payment processing infrastructure of the vendor website system.

19. The payment facilitation bureau of claim 18 wherein the number of payment processing gateways is one.

20. The payment facilitation bureau of claim 18 wherein the number of payment processing gateways is more than one.

21. The payment facilitation bureau of claim 18 wherein the transaction payment request is transmitted to the payment facilitation bureau from the vendor website system.

22. The payment facilitation bureau of claim 18 wherein the at least one server is also capable of communication with the client computer of the customer.

23. The payment facilitation bureau of claim 22 further comprising a bureau website system capable of interacting with the customer for acquisition of customer payment method details in respect of a transaction payment request.

24. The payment facilitation bureau of claim 22 wherein the customer provides the details of the selected customer payment method directly to the payment facilitation bureau by communication therewith, such that they are not received by the vendor website system.

25. The payment facilitation bureau of claim 18 wherein the number of payment issuance gateways is one.

26. The payment facilitation bureau of claim 18 wherein the number of payment issuance gateways is more than one.

27. A data processing system for facilitating an ecommerce transaction between a customer and a vendor website, the data processing system comprising:
i. at least one processing unit;
j. at least one memory storage device operatively coupled to the at least one processing unit; and
k. a program module stored in the at least one memory storage device operative for providing instructions to the at least one processing unit, the at least one processing unit responsive to the instructions of the program module, the program module operative for:
xii. receiving a transaction payment request in respect of an e-commerce transaction payment between a customer and a vendor website system, said transaction payment request identifying the transaction payment amount, the selected customer payment method, and the selected vendor accepted payment method;
xiii. obtaining customer payment method credentials by which the transaction amount can be charged to the selected customer payment method;
xiv. processing the transaction payment amount to the selected customer payment method using the obtained customer payment method credentials, via connection of the data processing system to at least one payment processing gateway;
xv. upon confirmation of the acceptance of the request for payment of the transaction payment amount from the at least one payment processing gateway, effecting the issuance of vendor payment credentials usable by the vendor website system to charge the transaction payment amount to the selected vendor accepted payment method, via connection of the data processing system to at least one payment issuance gateway;
xvi. assembling a transaction payment response in respect of the transaction payment request identifying the issued vendor payment credentials; and
xvii. transmitting the transaction payment response such that the issued vendor payment credentials can be used by the vendor website system to process payment in respect of the e-commerce transaction in question to the selected vendor accepted payment method.

28. The data processing system of claim 27 wherein the transaction payment request is transmitted to the data processing system from a client computer of the customer.

29. The data processing system of claim 27 wherein the transaction payment request is transmitted to the data processing system from the vendor website system 44.

30. The data processing system of claim 27 wherein the transaction payment response is transmitted from the data processing system to the client computer of the customer.

31. The data processing system of claim 27 wherein the transaction payment response is transmitted from the data processing system to the vendor website system.

32. The data processing system of claim 27 wherein the customer payment credentials are never available to the vendor website system.

33. The data processing system of claim 27 wherein the selected customer payment method is not a vendor accepted payment method of the vendor website system.

34. The data processing system of claim 27 wherein the selected customer payment method is a vendor accepted payment method of the vendor website system.

35. A computer readable memory having recorded thereon statements and instructions for execution by a data processing system to carry out the method of claim 1.

36. A payment facilitation client software program for execution on the computer of a customer in communication with a vendor website system, said client software program operative for:
i. Generating a transaction payment request in respect of an e-commerce transaction payment between the customer and the vendor website system, said transaction payment request identifying the transaction payment amount, the customer payment credentials by which a payment gateway can process a payment by a selected customer payment method, and the vendor accepted payment method;
ii. Transmitting said transaction payment request to a payment facilitation bureau capable of processing payments in accordance with the selected customer payment method, and capable of issuing vendor payment credentials which the vendor website system can use to process transaction payments using the vendor accepted payment method;
iii. Receiving back from said payment facilitation bureau a transaction payment response containing vendor payment credentials in respect of the vendor accepted payment method for the transaction; and
iv. Passing the vendor payment credentials from the transaction payment response to the vendor website system, whereby payment for the transaction can be processed and completed by the vendor website system;

37. The payment facilitation client software program of claim 36 wherein the transaction payment response is generated by the payment facilitation bureau by processing the transaction payment amount to the selected customer payment method using the obtained customer payment method credentials, via connection to at least one payment processing gateway; upon confirmation of the acceptance of the request for payment of the transaction payment amount from the at least one payment processing gateway, effecting the issuance of vendor payment credentials usable by the vendor website system 44 to charge the transaction payment amount to the selected vendor accepted payment method, via connection of the data processing system to at least one payment issuance gateway; assembling the transaction payment response in respect of the transaction payment request identifying the issued vendor payment credentials.

38. The payment facilitation client software program of claim 36 which is a software component working in conjunction with the Web browser of the customer computer.

39. The payment facilitation client software program of claim 36 wherein the customer payment credentials are never identified or provided to the vendor website system.

40. The payment facilitation client software program of claim 36 wherein the selected customer payment method is not a vendor accepted payment method.

41. The payment facilitation client software program of claim 36 wherein the selected customer payment method is a vendor accepted payment method.
